(19) United States
(12) Patent Application Publication
(10) Pub. No.: US 2009/0040303 A1
(43) Pub. Date: Feb. 12, 2009

(54) Automatic video quality monitoring for surveillance cameras

(75) Inventors: Alan M. Finn, Hebron, CT (US); Steven B. Rakoff, Toronto (CA); Pengju Kang, Yorktown Heights, NY (US); Pei-Yuan Peng, Ellington, CT (US); Ankit Tiwari, East Hartford, CT (US); Ziyou Xiong, West Hartford, CT (US); Lin Lin, Manchester, CT (US); Meghna Misra, Bolton, CT (US); Christian Maria Netter, West Hartford, CT (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Chubb International Holdings Limited, Farmington, CT (US)

(21) Appl. No.: 11/919,470

(22) PCT Filed: Apr. 29, 2005
(86) PCT No.: PCT/US2005/014665

§ 371 Date: Feb. 11, 2008

(51) Int. Cl. H04N 7/18; H04N 17/00; H04N 7/12

(52) U.S. Cl. 348/143; 348/192; 375/240.01; 348/E17.001; 348/E07.085; 375/E07.076

(57) ABSTRACT

A system for automatically determining video quality receives video input from one or more surveillance cameras (16a, 16b . . . 16N), and based on the received input calculates a number of video quality metrics (40). The video quality metrics are fused together (42), and provided to decision logic (44), which determines, based on the fused video quality metrics, the video quality provided by the one or more surveillance cameras (16a, 16b . . . 16N). The determination is provided to a monitoring station (24).

### BACKGROUND OF THE INVENTION

The field of the invention relates generally to automatic diagnostics and prognostics of video quality or lack thereof in video surveillance systems. Specifically, the invention relates to detecting conditions such as camera out-of-focus, lack of illumination, motion based blur, and misalignment/obscuration.

Conventional surveillance systems use multiple video cameras for detection of security breaches. Typically, surveillance cameras store large amounts of video data to a storage medium (for example a tape, digital recorder, or video server). Video data is only retrieved from the storage medium if an event necessitates review of the stored video data. Unfortunately, both the camera and communication links suffer from degradation, electrical interference, mechanical vibration, vandalism, and malicious attack. At the time of retrieval, if video quality has deteriorated due to any of these problems, then the usefulness of the stored video data is lost.

Detection of loss of video quality in conventional surveillance systems is limited to when a person notices that video quality is unacceptable. However, the time lag from the onset of video degradation to detection of the degradation may be long, since many surveillance systems are installed for forensic purposes and are not regularly viewed by guards or owners. The state of the art in automated video diagnostics for commercial surveillance systems is detection of complete loss of signal.

### BRIEF SUMMARY OF THE INVENTION

The present invention is a system for automatic video quality detection for surveillance cameras. Data extracted from video is provided to a video quality detection device that computes a number of video quality metrics. These metrics are fused together and provided to decision logic that determines, based on the fused video quality metric, the status of the video quality provided by the surveillance cameras. If a degradation of video quality is detected, then a monitoring station is alerted to the video quality problem so the problem can be remedied.

### BRIEF DESCRIPTION OF THE DRAWINGS

FIG. 1 is a diagram of a surveillance system in which the automatic video quality monitoring system of the present invention may be employed.

FIG. 2 is a functional block diagram of an embodiment of the automated video quality monitoring system employed within a digital video recorder.

FIG. 3 is a flowchart illustrating an embodiment of the steps taken by a video quality detection component within the digital video recorder to detect problems in video quality.

FIG. 4 is a flowchart illustrating another embodiment of the steps taken by the video quality detection component within the digital video recorder to detect problems in video quality.

FIG. 5 is a flowchart illustrating another embodiment of the steps taken by the video quality detection component within the digital video recorder to detect problems in video quality

### DETAILED DESCRIPTION

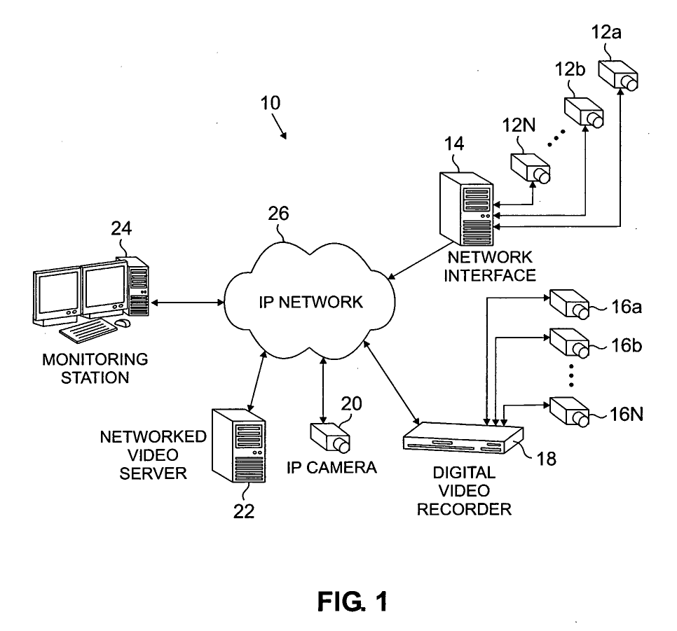

FIG. 1 illustrates an automatic video quality monitoring system 10, which includes a number of surveillance cameras 12a, 12b, . . . 12N (collectively “surveillance cameras 12”) that provide video data to network interface 14, a number of surveillance cameras 16a, 16b, . . . 16N (collectively “surveillance cameras 16”) that provide video data to digital video recorder (DVR) 18, Internet Protocol (IP) camera 20 which captures and, optionally, stores video data, and networked video server 22 which stores video data. Network interface 14, digital video recorder 18, IP camera 20 and networked video server 22 are connected to monitoring station 24 via a network, such as IP network 26 (e.g., the Internet). System 10 provides automatic video quality analysis on video captured or stored by surveillance cameras 12, surveillance cameras 16, IP camera 20, or networked video server 22. The automatic video quality analysis may be performed at a number of locations throughout system 10, including network interface 14, DVR 18, IP camera 20, networked video server 22 or monitoring station 24. To prevent having to communicate large amounts of video data across IP network 26, it is preferable to conduct the analysis closer to the source of the video data (i.e., closer to the surveillance cameras).

There are four common problems that often destroy the usefulness of stored surveillance data: out-of-focus, poor illumination, motion based blur, and misalignment/obscuration. System 10 provides for automatic detection of these problems by conducting automatic video quality analysis. The analysis begins with receiving video data captured by a surveillance camera, and calculating at least two video quality metrics based on the video data received. The video quality metrics are fused or combined together; and based on the fused video quality metric, a decision is made regarding the quality of video received from the surveillance camera. Data fusion is described in more detail, for instance, in Mathematics of Data Fusion by Irwin R. Goodman et al., Kluwer Academic Publishers, 1997.

The result of the automatic video quality analysis (provided the analysis was not conducted at monitoring station 24) is communicated to monitoring station 24 to alert maintenance personnel of any video quality problems. Video quality metrics provide an automatic assessment of the quality of video received that otherwise would require that a person physically review the received video to determine whether it is useful or not. Furthermore, video quality metrics often detect changes or trends in video quality that would be unnoticeable to the human eye. Different metrics are employed to detect different aspects of video quality. By fusing a number of metrics together, accurate detection of the video quality provided by surveillance cameras is provided.

For the sake of simplicity, the following discussion provides examples in which video data captured by surveillance cameras 16a, 16b, . . . 16N (collectively “surveillance cameras 16”) are provided to digital video recorder 18, which conducts the automatic video quality analysis and provides results of the analysis to monitoring station 24 via IP network 26.

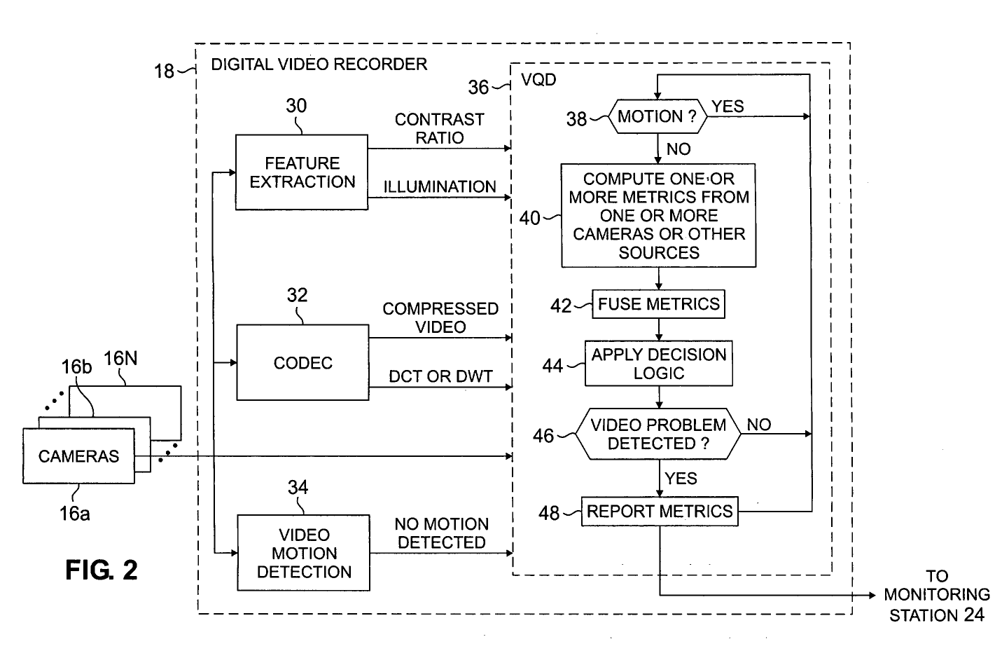

FIG. 2 shows a view of components included within DVR 18 as well as a general flow chart outlining the algorithm employed to detect video quality problems. Video captured by surveillance cameras 16 is provided to DVR 18. Video data is processed by components located in DVR 18, including feature extraction 30, coder/decoder (CODEC) 32, and video motion detection 34. Output from each of these components as well as raw video data from surveillance cameras 16 is provided to video quality detection (VQD) 36, which uses the input provided to calculate a number of video quality metrics. VQD 36 combines or fuses the video quality metrics into a fused video quality metric that is used to determine whether video problems exist. It is not necessary that the computation of video quality metrics occur at the same rate as capture of images from cameras 16.

Calculating a number of video quality metrics is oftentimes computationally expensive. To reduce the number of computations that must be performed, the embodiment shown in FIG. 2 makes use of the compression algorithm already employed by DVR 18. Video data provided by surveillance cameras 16 typically require a large amount of storage space, and may need to be converted to digital format before being stored or transmitted. Thus, DVR 18 employs CODEC 32 to compress raw video data to a smaller digital format. CODEC 32 may use a discrete cosine transformation (DCT) or discrete wavelet transform (DWT) to perform the coding or compression operation. A by-product of the compression operation is the creation of DCT or DWT coefficients that are useful in calculating a number of video quality metrics related to out-of-focus conditions. Because CODEC 32 provides the DCT or DWT coefficients as part of the compression process, video quality metrics that make use of DCT or DWT coefficients are computationally cheaper to perform. The DCT or DWT coefficients are provided to VQD 36.

Feature extraction 30 also provides data to VQD 36 that is useful in calculating video quality metrics. For instance, feature extraction 30 provides VQD 36 with video data regarding illumination, intensity histogram, and/or contrast ratio of the video data to be analyzed. Illumination data is typically a value indicating the total intensity of video data being analyzed. An intensity histogram is typically a distribution of intensity values in an image. Contrast ratio data is typically the difference between the darkest pixel and the lightest pixel in the video data being analyzed. Any of these values may be used to form video quality metrics useful in analyzing the video data.

VQD 36 uses the video data provided by the components described above to calculate a number of video quality metrics, which are then used to detect the presence of problems in video quality. VQD 36 begins the analysis at Step 38 by checking whether motion has been detected in the video data to by analyzed. Data regarding whether motion has been detected is provided by video motion detection 34. While video motion detection 34 is a common existing feature of digital video recorders 18, it may be specifically provided if it is not already available. The presence of motion in the video data to be analyzed oftentimes results in erroneous video quality metrics and thus analysis. Thus, if motion is detected in the video data, then VQD 36 waits until video data is received without motion before continuing with the rest of the analysis. If no motion is detected, then at Step 40 a number of video quality metrics are calculated. At Step 42, the video quality metrics are fused or combined together. Fusing metrics is defined as any sort of useful combination of the video quality metrics calculated. This may include numerical combination, algebraic combination, weighted combination of parts, or organization into a system of values.

The fused video quality metrics are then provided to decision logic at Step 44. Decision logic determines based on the fused video quality metric provided whether or not a problem with video quality exists. If multiple problems are detected, e.g., out of focus and obscuration, then the problems will be prioritized and one or more will be reported. If a video quality problem is detected at Step 46, then the video quality metrics are reported to monitoring station 24 at Step 48. If decision logic determines that no problem exists at Step 46, then no report is sent to monitoring station 24, and the analysis process begins again with the next set of video data. If a report is sent to monitoring station 24 and an operator determines that no problem exists or that it does not warrant repair, the operator may adjust the computation of the video quality metrics, especially the setting of alarm thresholds, to minimize further unnecessary reports.

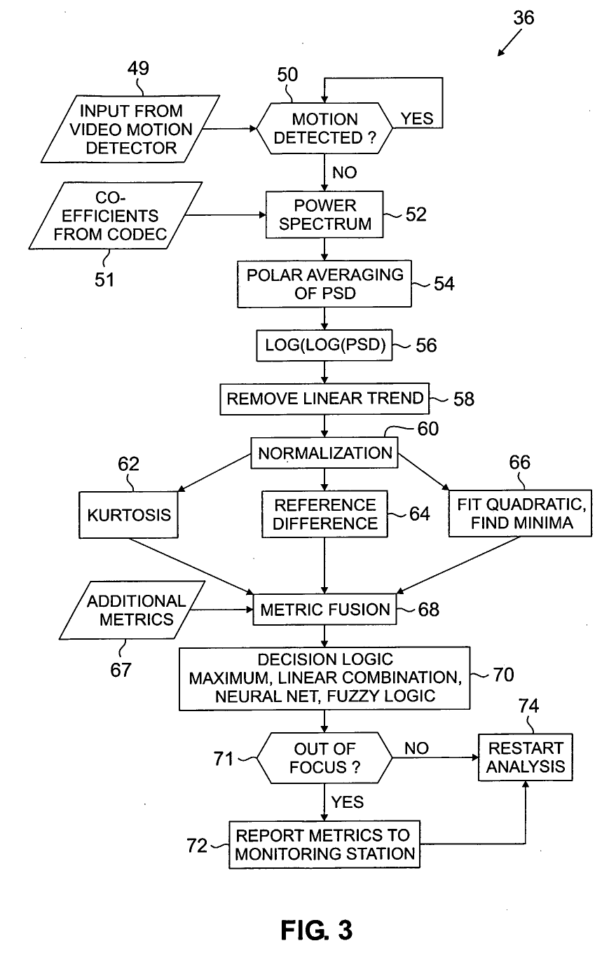

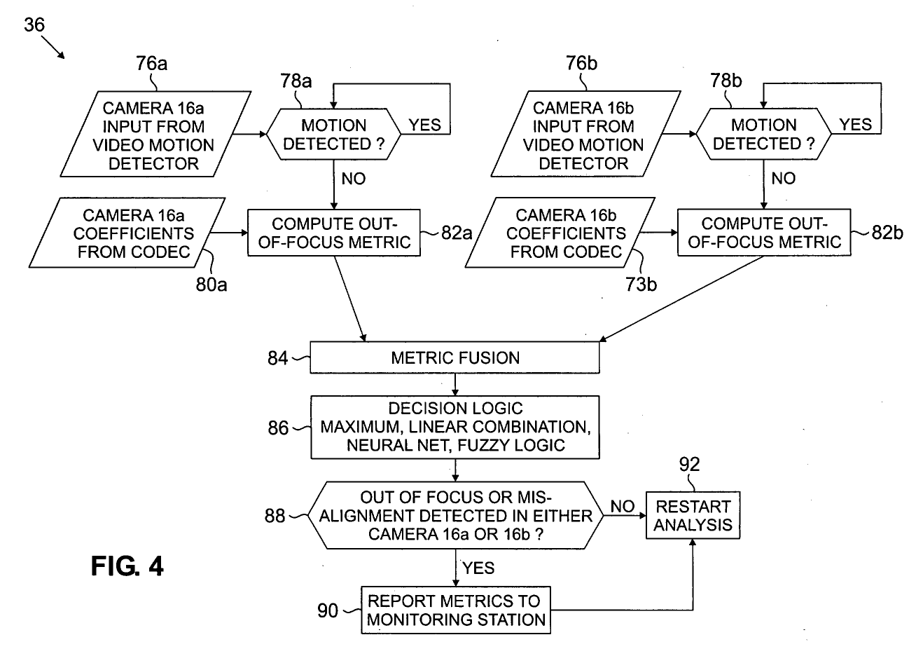

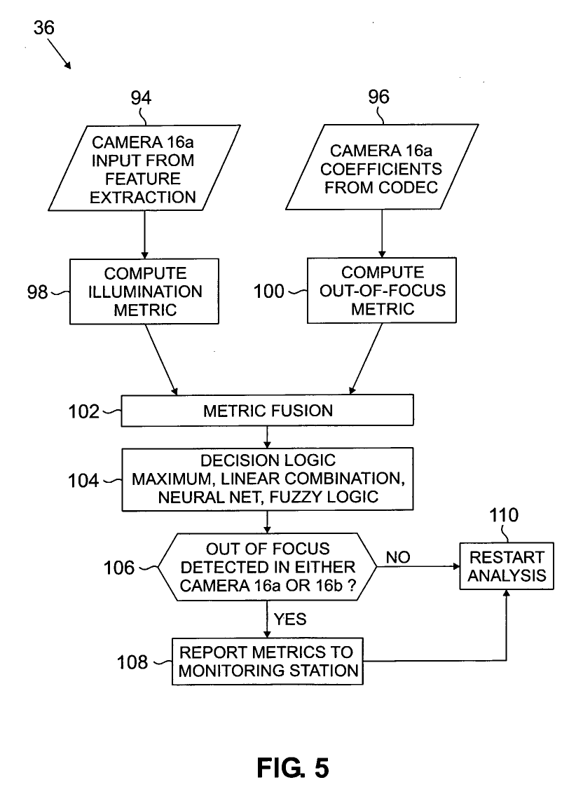

FIGS. 3-5 illustrate three scenarios commonly employed by VQD 36 in detecting problems with video quality. FIG. 3 shows an embodiment indicative of the first scenario, in which a number of metrics related to a single video problem (i.e. out-of-focus) are calculated from a single camera and combined or fused to detect if a particular video problem associated with the video quality metrics is present. FIG. 4 shows an embodiment indicative of the second scenario, in which a number of cameras focused on a similar region of interest (ROI) are analyzed by comparing a video quality metric common to all of the cameras. FIG. 5 shows an embodiment indicative of the third scenario, in which two different metrics (e.g. a first metric concerning illumination, and a second metric concerning out-of-focus) are combined to provide a more accurate assessment of one video problem (e.g. out-of-focus).

FIG. 3 shows an embodiment indicative of the first scenario, in which VQD 36 uses information provided by CODEC 32 to calculate a number of out-of-focus metrics to detect if an individual camera (surveillance camera 16a) is out-of-focus. Video motion detection data 49 is provided to VQD 36 at Step 50 by video motion detection component 34. If video motion detection data 49 indicates motion in the video data provided, then VQD 36 prevents further analysis and continues to monitor input from video motion detection 34 until such time that no video motion is detected. This screening process prevents analysis of video data including motion, which oftentimes leads to erroneous video quality metrics and quality analysis.

If no motion is detected at Step 50, then VQD 36 proceeds to perform the out-of-focus analysis using coefficients 51 provided by CODEC 32. VQD 36 begins by computing a power spectrum density (PSD) based on the coefficients at Step 52. The resulting PSD is converted to a polar average PSD at Step 54. VQD 36, at Step 56, takes the log of (logPSD), followed by removing linear trends at step 58 and normalization at step 60. From this value, and the video data, VQD 36 calculates three video quality metrics to aid in detection of an out-of-focus condition.

The first out-of-focus metric is the kurtosis, calculated at step 62, which is a statistical analysis of the video data provided. VQD 36 compares the calculated kurtosis to an expected kurtosis value indicative of a focused image (i.e., should have a value equal to about 3). When an image is out of focus, poorly illuminated, or obscured, the distribution of intensity will increasingly deviate from normal and the kurtosis will deviate from the kurtosis of a normal distribution, i.e., 3.

The second video quality metric calculated at Step 64 is the reference difference between the out-of-focus metric calculated with respect to the current video data as compared with an out-of-focus metric calculated with respect to a known in-focus image. Differences between the two out-of-focus metrics indicate an out-of-focus condition. This difference may be normalized against mean value of the image intensity, or any other known quantity to make the measure more or less invariant to lighting changes.

The third video quality metric calculated at Step 66 involves computing the power spectral density (PSD) and finding the minima of the PSD, e.g., using a quadratic curve fit or integrating the power spectral density in high spatial frequencies for comparison to an adaptive threshold, which is set according to the nature of the scene the camera is monitoring.

For the quadratic fitting method, the PSD is first de-trended. After de-trending, the data is divided into segments of equal length. Consecutively, a quadratic curve is fitted to the data segments. The local valley (minimum) of each segment is located using this fitted curve. The location and depth of the deepest valley is related to the degree out of focus. If the depth is small, then the image is well focused. If the depth has a significant value, then the location of the valley in reference to the origin is directly related to the degree of focus. The nearer the location is to the origin, the more severe the degree of out of focus. There are variations to this method. One such variation is just to detect whether there is a valley of significant magnitude in the PSD. If there is a valley detected, out of focus is considered to be detected.

The integration method refers to the procedure of dividing the image into sub-blocks, followed by the computation of the PSD of each block. The resultant PSDs of the blocks are integrated (averaged) together to have a final PSD representation of the image. This helps remove the effect of noise on the detection performance. In a similar way, a statistical measure can be devised to describe the shape change of the averaged PSD. One such a method is to count the number of frequency bins whose magnitudes are less than a predefined threshold. This total count number can be normalized against the total number of blocks to make the counting measure invariant to image size and scene. Another method is to compare a ratio of high frequency energy (summed magnitude of high frequency bins) to low frequency energy (summed magnitude of low frequency bins) of total energy (summed magnitude of all bins).

There are other ways to describe the changes of the PSD curve of the video images statistically. Fundamentally these other methods do not deviate for the spirit of this invention, which teaches a method of using statistical measure to gauge the changes of PSD shapes when video quality degrades.

One or more metrics are then fused together along with any other video quality metrics 67 that are appropriate at step 68. For example, other video quality metrics associated with out-of-focus are Fast Fourier Transforms (FFT), Wavelet Transforms (WT) and Point Spread Functions (PSF). The resulting fused metric is provided to decision logic at step 70.

Decision logic at Step 70 decides whether an alert should be sent to monitoring center 24 regarding video quality in camera 16a. Decision logic may make use of a number of techniques, including the comparing of the fused metric value with a maximum allowable fused metric value, linear combination of fused metrics, neural net, Bayesian net, or fuzzy logic concerning fused metric values. Decision logic is additionally described, for instance, in Statistical Decision Theory and Bayesian Analysis by James O. Berger, Springer; 2 ed. 1993. At Step 71, if decision logic determines that the video quality is out-of-focus (diagnosis) or is trending towards being out-of-focus (prognosis) then a report is sent to monitoring station 24 at Step 72, and the analysis is renewed at Step 74. If no out-of-focus problems are detected, then no report is sent to monitoring station 24 and analysis is renewed at Step 74.

While FIG. 3 was directed towards detecting an out-of-focus condition, in other embodiments VQD 36 would instead test for illumination problems, misalignment/obscuration, or motion blurring problems. For each individual problem, VQD 36 would calculate a number of video quality metrics associated with that problem. After fusing the number of metrics together, decision logic would determine whether the current surveillance camera is experiencing a video quality problem. In other embodiments, rather than diagnostically checking data at a particular moment in time to determine if surveillance camera 20 has a video quality problem, video quality metrics are monitored over time to detect trends in video quality. This allows for prognostic detection of video problems before they become severe. As shown in FIG. 3, a number of out-of-focus metrics are calculated with regard to surveillance camera 16a to determine if it is out-of-focus. In another embodiment, previously computed out-of-focus metrics for surveillance camera 16a would be compared with current out-of-focus metrics for surveillance camera 16a to determine if surveillance camera 16a is trending towards an out-of-focus state.

FIG. 4 shows an exemplary embodiment indicative of the second scenario, in which VQD 36 compares similar video quality metrics from multiple cameras to detect decrease of video quality in any one of the cameras. Surveillance cameras 16a and 16b are directed towards a shared region of interest (ROI), meaning that each camera is seeing at least in part a similar viewing area. Video motion detection data 76a and 76b is provided to VQD 36 from respective surveillance cameras 16a and 16b. If no motion is detected at steps 78a and 78b, then VQD 36 computes out-of-focus metrics from DCT coefficients 80a and 80b from respective cameras 16a and 16b at steps 82a and 82b. In this embodiment, out-of-focus metrics are again calculated from the DCT or DWT coefficients provided by CODEC 32 as discussed above with respect to FIG. 3 (e.g., Kurtosis, Reference Difference, and Quadratic Fit). For the sake of simplicity, the calculation of out-of-focus metrics discussed in detail in FIG. 3 is shown as a single step in FIG. 4. Hence, input from surveillance cameras 16a and 16b is provided to CODEC 32, which in turn provides DCT or DWT coefficients 80a and 80b to VQD 36. Out-of-focus metrics are calculated at steps 82a and 82b. The out-of-focus metrics associated with surveillance cameras 16a and 16b are fused at Step 84, the result of which is provided to decision logic at Step 86.

Fusing out-of-focus metrics from different surveillance cameras sharing a region of interest allows VQD 36 to test for video problems associated with the video metrics calculated (in this case, out-of-focus) as well as camera misalignment/obscuration. Out-of-focus problems can be determined by comparing the respective out-of-focus metrics from surveillance cameras 16a and 16b. For instance, if the out-of-focus metrics associated with camera 16a indicate an out-of-focus condition, and the out-of-focus metrics associated with camera 16b indicate an in-focus condition, then decisional logic relies on the comparison of the two metrics to determines that camera 16a is out-of-focus. Comparing focus conditions between two cameras works best if the cameras share a region of interest, i.e., similar objects appear in the fields of view of both cameras.

The second video problem, misalignment/obscuration, can also be detected by comparing the out-of-focus metrics calculated from surveillance cameras 16a and 16b. To determine if camera 16a or 16b is misaligned or obscured, it is again important that the images intended to be captured from each camera be focused on or share a common ROI. If cameras 16a and 16b share a common ROI, then out-of-focus metrics (or other video quality metrics) calculated from each camera should provide similar results under normal conditions if both cameras are aligned and not obscured. If out-of-focus metrics for the two cameras vary, this indicates that one camera is misaligned or obscured.

If either out-of-focus or misalignment/obscuration is detected at Step 88, then at Step 90 the video quality problem is reported to monitoring station 24. If no video problem is detected, then the analysis is started again at Step 92.

The concept shown in FIG. 4 with respect to out-of-focus metrics applies also to other video quality metrics, such as those calculated from illumination, intensity histogram, and contrast ratio data provided by feature extraction 30. That is, if cameras 16a and 16b share a common ROI, then they should have similar video quality metrics (i.e. metrics based on illumination, intensity histogram, contrast ratio). Differences between video quality metrics indicate video quality problems. Difference in video quality metrics from different cameras with a shared ROI may also indicate misalignment or obscuration of one of the cameras. In other embodiments, more than two cameras may be compared to detect video quality problems.

FIG. 5 is a flow chart of an exemplary embodiment of another algorithm employed by VQD 36 to determine whether camera 16a is experiencing a decrease in video quality (e.g., out-of-focus, illumination, motion-blur, or misalignment). In this embodiment, video quality metrics related to different video quality problems (e.g., out-of-focus and illumination) are combined to determine if camera 16a is out-of-focus. Input 94 from feature extraction 30 related to illumination and/or contrast ratio and DCT or DWT coefficients 96 from CODEC 32 are provided to VQD 36. At steps 98 and 100, VQD 36 calculates illumination metrics and out-of-focus metrics, respectively. These metrics are fused at Step 102, and provided to decision logic at Step 104. Decision logic uses the illumination metric to dictate the level of scrutiny to apply towards the out-of-focus metric. For example, if surveillance camera 16a is placed in an outdoor setting, the illumination metric will reflect the decrease in light as the sun sets. If VQD 36 calculates and analyzes out-of-focus metrics in this low light setting, it may appear that camera 16a is losing focus, when in reality it is just getting dark outside. By fusing the illumination metric to the out-of-focus metric at Step 102, and then providing the metrics to decision logic at Step 104, this loss of light can be taken into account. In this instance, as the illumination metric indicates a loss of light, decision logic takes this into account when determining whether an out-of-focus condition exists. If out-an out-of-focus problem is detected at Step 106, then it is reported at Step 108 to monitoring station 24. Otherwise the process begins again at Step 110.

The present invention therefore describes a system for automatically detecting problems with video quality in surveillance cameras by calculating and fusing a number of video quality metrics. This allows the system to provide information regarding the status of video quality from a number of surveillance cameras with a low risk of false alarms. In this way, a maintenance center is able to ensure that all surveillance cameras are providing good quality video.

The present invention is not limited to the specific embodiments discussed with respect to FIGS. 2-5. For example, in other embodiments, a combination of the scenarios discussed with respect to FIGS. 3-5 may be employed by VQD 36. Although described in the context of DVR 18, the analysis can be performed at other components within the system, such as network interface 14, IP camera 20, video server 22 or monitoring station 24.

Although the present invention has been described with reference to preferred embodiments, workers skilled in the art will recognize that changes may be made in form and detail without departing from the spirit and scope of the invention.

1. A method for automatically detecting video quality, the method comprising:
receiving a video input;
computing a first video quality metric and a second video quality metric based on the video input;
fusing the first video quality metric and the second video quality metric into a fused video quality metric; and
determining video quality of the video input by applying decisional logic to the fused video quality metric.

2. The method of claim 1, further including:
communicating determined video quality to a maintenance station.

3. The method of claim 2, further including:
providing the video input to a video motion detector;
using the video motion detector to detect motion in the video input; and
preventing communicating said determined video quality to a maintenance station if motion is detected in the video input by the video motion detector.

4. The method of claim 1, wherein the first and second video quality metrics include at least one of the following:
an out-of-focus metric; and
an illumination metric.

5. The method of claim 1, further including:
providing the video input to a video motion detector;
using the video motion detector to detect motion in the video input; and
preventing computing of the first and second video quality metrics if motion is detected in the video input by the video motion detector.

6. The method of claim 1, wherein the video input is derived from a surveillance camera.

7. The method of claim 1, wherein computing a first video quality metric and a second video quality metric further comprises:
providing the video input to a coder/decoder (CODEC);
calculating a transform coefficients using the CODEC; and
calculating the first and second video quality metrics based on the transform coefficients provided by the CODEC.

8. The method of claim 1, wherein computing a first video quality metric and a second video quality metric further comprises:
providing the video input to a feature extraction;
measuring a contrast ratio value and an illumination value of the video input; and
calculating the first and second video quality metrics additionally using at least one of the contrast ratio value and the illumination value of the video input.

9. The method of claim 1, wherein the video input is a first video signals from a first camera and a second video signals from a second camera; and wherein the first video quality metric is derived from the first video signals, and the second video quality metric is derived from the second video signals.

10. The method of claim 1, wherein computing a first video quality metric and a second video quality metric further comprises:
providing the video input to a coder/decoder (CODEC), wherein the CODEC computes transform coefficients using the CODEC;
providing the video input to a feature extraction, wherein the feature extraction measures a contrast ratio value and an illumination ratio value;
calculating the first video quality metric using transform coefficients provided by the CODEC; and
calculating the second video quality metric using contrast ratio value and/or illumination values provided by the feature extraction.

11. The method of claim 10, wherein determining the video quality of the video input further includes using the second video quality metric to determine the level of scrutiny to apply in determining the video quality based on the first video quality metric.

12. A system for monitoring video quality, the system comprising:
a first surveillance camera for capturing video data; and
a video quality detector for determining video quality of the video data provided by the first surveillance camera, wherein the video quality detector computes a first video quality metric and a second video quality metric, fuses the first and second video quality metric into a fused video quality metric, and determines video quality based on the fused video quality metric.

13. The system of claim 12, further including:
a monitoring station connected for receiving reports from the video quality detector concerning video quality of the first surveillance camera.

14. The system of claim 12, wherein the first and the second video quality metrics include at least one of the following:
an out-of-focus metric; and
an illumination metric.

15. The system of claim 12, further including a video motion detector that receives video data from the first surveillance camera and provides output to the video quality detector, wherein if the video motion detector determines that the video data captured by the first surveillance camera contains motion, then the video quality detector does not determine video quality until no motion is detected.

16. The system of claim 12, further including a coder/decoder (CODEC) that receives video data from the first surveillance camera and provides, based on the video data from the first surveillance camera, compressed video data and transform coefficients to the video quality detector; wherein the video quality detector calculates the first video quality metric and the second video quality metric based on the video and transform coefficients provided by the CODEC.

17. The system of claim 16, further including a feature extractor that receives video data from the first surveillance camera and provides, based on the video data from the first surveillance camera, contrast ratio measurements and illumination measurements; wherein the video quality detector calculates the first video quality metric based on input provided by the CODEC and the second video quality metric based on the contrast ratio measurements and illumination measurements provided by the feature extractor.

18. The system of claim 12, further including a feature extractor that receives video data from the first surveillance camera and provides, based on the video data from the first surveillance camera, contrast ratio measurements and illumination measurements; wherein the video quality detector calculates the first video quality metric and the second video quality metric based on the contrast ratio measurements and illumination measurements.

19. The system of claim 12, further including a second surveillance camera for capturing video data, wherein the first video quality metric is calculated from video data provided by the first surveillance camera and the second video quality metric is calculated from video data provided by the second surveillance camera.

20. A method for detecting problems with video quality, the method comprising:
receiving video input;
receiving input from a motion detector regarding motion detected in video input;
preventing further analysis if motion is detected;
calculating a first video quality metric based on video input received;
calculating a second video quality metric based on video input received;
fusing the first and second video quality metrics calculated into a fused video quality metric; and
using the fused video quality metric to determine whether video quality of received video input has deteriorated.
